(19) United States
(12) Patent Application Publication
(10) Pub. No.: US 2008/0021773 A1
(43) Pub. Date: Jan. 24, 2008

(54) METHOD FOR DISPLAYING EXPANDED ADVERTISEMENT

(75) Inventors: JONG WON LEE, SEONGNAM-SI (KR); SOONHONG KWON, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, SEONGNAM-SI (KR)

(21) Appl. No.: 11/780,804

(22) Filed: Jul. 20, 2007

(30) Foreign Application Priority Data
Jul. 20, 2006 (KR) 10-2006-0067927

(51) Int. Cl. G06Q 30/00; G06F 17/30

(52) U.S. Cl. 705/14

(57) ABSTRACT

Disclosed herein is a method for displaying an expanded advertisement in which advertisement data including an optimized value is displayed when user's interaction satisfies the optimized value. The method for displaying the expanded advertisement comprises displaying advertisement data when detecting that an user accesses a service page, determining existence of an user's interaction of the client with respect to the displayed advertisement on the service page, verifying whether the interaction of the client satisfies a predetermined advertisement displaying basis when the interaction of the client exists, and displaying the expanded advertisement data when the interaction of the client satisfies the advertising displaying basis.

### CROSS-REFERENCE TO RELATED APPLICATION

This application claims priority from Korean Patent Application No. 10-2006-0067927, filed on Jul. 20, 2006, in the Korean Intellectual Property Office, the entire disclosure of which is incorporated herein by reference.

### BACKGROUND

1. Field

The present disclosure relates to a method for displaying an advertisement, and more particularly, to expanding an advertisement displayed on a display screen.

2. Discussion of the Related Technology

Generally, advertising means information activities in which individuals, companies, or organizations publicly announce goods, services, ideas, policies, and the like, to attain specified purposes. The advertising is provided to the public in the form of letters, pictures, voices, and the like through public media such as television, radio, the Internet, and the like, thereby advertising goods, services, and the like, to the public.

In particular, the Internet is used by a number of people regardless of location, sex and age, and thus, purposes of advertising are effectively attained through the Internet. This is because a main purpose of using the Internet is to obtain desired information. When a search word of desired information is inputted, information associated the search word may be provided along with related advertisements, thereby maximizing advertising effect.

### SUMMARY

One aspect of the invention provides a method for displaying an advertisement, the method comprising: receiving, by a computing device, advertisement data from a remote source, wherein the advertisement data is configured to display an advertisement on a display screen associated with the computing device, wherein the advertisement data comprises an optimized condition for expanding the advertisement such that further information relating to the advertisement is to be displayed on the display screen; monitoring, by the computing device, a user input to the computing device; determining, by the computing device, whether the user input satisfies the optimized condition; and expanding the advertisement so as to display the further information on the display screen when the user input satisfies the optimized condition.

In the foregoing method, the user input may comprise at least one of a stay of a pointer over the advertisement on the display screen and a keyboard input to the computing device. The optimized condition may be produced by a method which may comprise providing statistical data of a period during which Internet users stay their pointers over an Internet advertisement that is configured to expand the Internet advertisement to display additional information when a pointer is placed over the Internet advertisement, and determining the optimized condition based on the statistical data. The optimized condition may comprise a threshold, which is a minimum period required for a pointer to stay over the advertisement for displaying the further information.

Still in the foregoing method, the optimized condition may be produced by a method which comprises: providing first statistical data of a period during which Internet users stay their pointers over Internet advertisements, each of which is configured to expand the Internet advertisement to display additional information when a pointer is placed over the Internet advertisement, wherein the first statistical data is obtained in a context where the Internet advertisement that is displayed on a first type of webpages; providing second statistical data of a period during which Internet users stay their pointers over Internet advertisements, each of which is configured to expand the Internet advertisement to display additional information when a pointer is placed over the Internet advertisement, wherein the second statistical data is obtained in a context where the Internet advertisement that is displayed on a second type of webpages, which is different from the first type; and determining the optimized condition comprising a first optimized value based on the first statistical data and a second optimized value based on the second statistical data, wherein the first value is a minimum period required for a pointer to stay over the advertisement for displaying the further information when the advertisement is displayed in a webpage of the first type, wherein the second value is a minimum time required for a pointer to stay over the advertisement displaying the further information when the advertisement is displayed in a webpage of the second type. The first type of webpages may comprise news media webpages, and the second type of webpages may comprise individuals' blog webpages. The first value may be smaller than the second value. The first value may be smaller than the second value by a range from about 0.03 seconds to about 0.07 seconds. The first value may be from about 0.18 seconds to about 0.22 seconds.

Another aspect of the invention provides a computer executable command for use in connection with a webpage, wherein the command is to initiate the foregoing method.

Still another aspect of the invention provides a method for displaying an advertisement, the method comprising: receiving, by a computing device, advertisement data configured to display an advertisement on a display screen associated with the computing device, wherein the advertisement data comprises a predetermined condition for expanding the advertisement such that further information relating to the advertisement is to be displayed on the display screen, wherein the predetermined condition comprises a minimum period that is required for a pointer to stay over the advertisement for displaying the further information; and expanding the advertisement so as to display the further information on the display screen when the pointer stays over the advertisement for the minimum period or longer.

In the foregoing method, the computing device may monitor motions of the pointer so as to determine whether the pointer stays over the advertisement for the minimum period or longer. The minimum period may be longer than about 0.18 seconds. The minimum period may be longer than about 0.25 seconds. The minimum period may be longer than about 0.4 seconds.

A further aspect of the invention provides a method for displaying advertisements, the method comprising: receiving, by a computing device, first advertisement data configured to display a first advertisement along with a first webpage on a display screen associated with the computing device, wherein the first advertisement data further comprises a first predetermined condition for expanding the first advertisement such that first additional information relating to the first advertisement is to be displayed on the display screen, wherein the first predetermined condition comprises a first minimum period that is required for a pointer to stay over the first advertisement for displaying the first additional information; expanding the first advertisement so as to display the first additional information on the display screen when a pointer on the display screen stays over the first advertisement for a period that is identical to or longer than the first minimum period; receiving, by the computing device, second advertisement data configured to display a second advertisement along with a second webpage on the display screen, wherein the second advertisement data further comprises a second predetermined condition for expanding the second advertisement such that second additional information relating to the second advertisement is to be displayed on the display screen, wherein the second predetermined condition comprises a second minimum period that is required for a pointer to stay over the second advertisement for displaying the second additional information; expanding the second advertisement so as to display the second additional information on the display screen when a pointer on the display screen stays over the second advertisement for a period that is identical to or longer than the second minimum period; and wherein the first minimum period differs from the second minimum period.

In the foregoing method the first webpage may be a news media webpage, and the second webpage may be an individual's blog. The first minimum period may be shorter than the second minimum period. The first minimum period may be shorter than the second minimum period by a range from about 0.03 seconds to about 0.07 seconds. The first minimum period may be from about 0.18 seconds to about 0.22 seconds.

An aspect of the present invention provides a system and a method for displaying an expanded advertisement in which advertisement data including an optimized value is displayed on a service page, and whether interaction of a client satisfies the optimized value is determined when the interaction of the client exists with respect to the displayed advertisement, thereby displaying expanded advertisement, and accordingly, maximizing advertising effect.

Another aspect of the present invention provides a system and a method for displaying an expanded advertisement in which since interactions of each client are varied according to characteristics of each service page such as news, e-mail, a blog, a dictionary, and the like, based on statistical information of mouse-over time and duration time of each client, a different optimized value is set for each service page.

Also, another aspect of the present invention provides a system and a method for displaying an expanded advertisement in which an optimized value is re-determined by obtaining interactions of each client when expanded advertisement is displayed, so that a displayed timing of the expanded advertisement depending on user's reactions is effectively determined.

An aspect of the present invention provides a method for displaying expanded advertisement comprising displaying advertisement data when detecting that a client accesses a service page; determining existence of interaction of the client with respect to the displayed advertisement on the service page; verifying whether the interaction of the client satisfies a predetermined advertisement displaying basis when the interaction of the client exists; and displaying the expanded advertisement when the interaction of the client satisfies the advertising displaying basis.

In the foregoing method, the displaying of the advertisement data includes identifying an optimized value associated with the advertisement data from a user type database and displaying the advertisement data including the identified optimized value, and the verifying includes verifying whether the interaction of the client satisfies the optimized value included in the advertisement data. The user type database determines an optimized value based on statistical information of mouse over time during which a mouse cursor of each client performs a mouse over on advertisement data, and statistical information of duration time during which a location of the mouse cursor of each client having performed a mouse over on advertisement data is changed to a location extraneous of the advertisement data, and then records the determined optimized value in the advertisement data. A different optimized value is set for each service page. The different optimized value is set for each service page in consideration of a user's attribute.

Still in the foregoing method, the determining includes determining whether the mouse cursor of the client performs a mouse over on the displayed advertisement data. The foregoing method further comprises re-determining the optimized value depending on interactions of each client by observing interactions of each client for a predetermined period of time and recording the re-determined optimized value in the user type database. When a service page connected by the client is a reading service page, the optimized value is set lower than that of other service pages. A service page connected by the client is a writing service page, the optimized value is set higher than that of other service pages. Another aspect of the invention provides A computer-readable recording medium storing a program for implementing the foregoing method.

Another aspect of the present invention provides a system for displaying an expanded advertisement comprising an advertisement data displaying unit configured to display advertisement data when detecting that a client accesses a service page; an interaction determining unit configured to determine existence of interaction of the client with respect to the displayed advertisement on the service page; and an advertisement basis verifying unit configured to verify whether the interaction of the client satisfies a predetermined advertisement displaying basis when the interaction of the client exists, wherein the advertisement data displaying unit displays the expanded advertisement when the interaction of the client satisfies the advertisement displaying basis.

In the foregoing system, the system further comprises an advertisement data controlling unit configured to identify an optimized value associated with the advertisement data from a user type database and permit the identified optimized value to be included in the advertisement data, wherein the advertisement data displaying unit displays advertisement data including the optimized value, and the advertisement basis verifying unit verifies whether the interaction of the client satisfies the optimized value included in the advertisement data. The system further comprises a user type database configured to determine an optimized value based on statistical information of mouse over time during which a mouse cursor of each client performs a mouse over on advertisement data and statistical information of duration time during which a location of the mouse cursor of each client having performed a mouse over on advertisement data is changed to a location extraneous of the advertisement data, and then record the determined optimized value in the advertisement data. The advertisement data controlling unit sets a different optimized value for each service page and records the set optimized value in the user type database. The advertisement data controlling unit re-determines the optimized value depending on the interactions of the client and records the re-determined optimized value in the user type database. The interaction determining unit determines whether the mouse cursor of the client performs a mouse over on the displayed advertisement data.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration of a system for displaying an expanded advertisement according to an exemplary embodiment of the present invention;

FIG. 2 is a flowchart illustrating a method for displaying expanded advertisement according to another exemplary embodiment of the present invention;

FIG. 3 is a diagram illustrating an example of a user type database according to an exemplary embodiment of the present invention;

FIGS. 4A and 4B are graphs illustrating distribution of time statistics based on interactions of clients according to an exemplary embodiment of the present invention;

FIGS. 5A and 5B are graphs illustrating an example of distribution of interactions of clients in a service page having a read property according to an exemplary embodiment of the present invention;

FIGS. 6A and 6B are graphs illustrating an example of distribution of interactions of clients in a service page having a write property according to an exemplary embodiment of the present invention; and

FIG. 7 is a view illustrating an example in which expanded advertisement is displayed according to an exemplary embodiment of the present invention.

### DETAILED DESCRIPTION OF EMBODIMENTS

Reference will now be made in detail to exemplary embodiments of the present invention, examples of which are illustrated in the accompanying drawings. The exemplary embodiments are described below in order to explain the present invention by referring to the figures.

An advertisement displayed along with a webpage may be expanded and displayed over a larger advertisement region than an original advertisement region when a mouse button is clicked or a mouse pointer is positioned over the advertisement region. However, the expanded advertisement may be displayed even when the mouse cursor is positioned on the advertisement region without the user's intention. This may cause the advertisement region to occupy a relatively large area of the display screen. As a result, the advertisement which a user does not wish to see may be undesirably displayed.

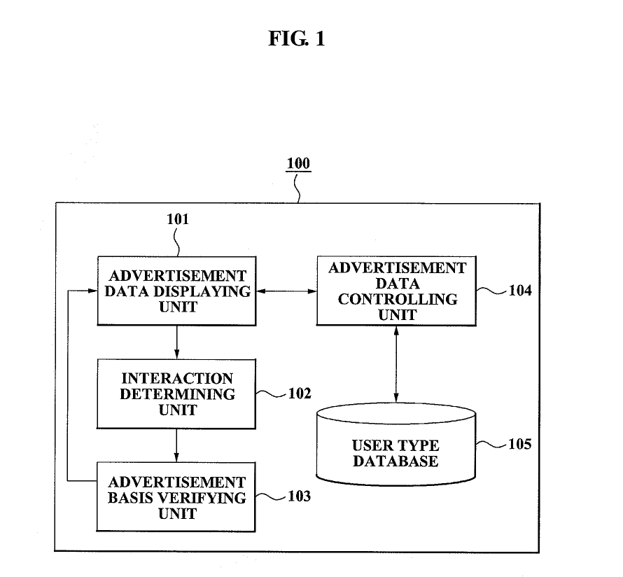

FIG. 1 is a block diagram illustrating a configuration of a system 100 for displaying an expanded advertisement according to an exemplary embodiment of the present invention. The system 100 for displaying an expanded advertisement according to an embodiment of the invention includes an advertisement data displaying unit 101 configured to display an advertisement when detecting that an user accesses a webpage or service page, an interaction determining unit 102 configured to determine existence of an user's input or interaction with respect to the displayed advertisement on the service page or webpage; and an advertisement basis verifying unit 103 configured to verify whether the user's input or interaction satisfies a predetermined advertisement displaying condition when the user's interaction exists. In this instance, the advertisement data displaying unit 101 displays an expanded advertisement when the user's interaction satisfies the advertisement displaying basis.

The system 100 for displaying expanded advertisement according to an embodiment of the present invention further includes an user's interaction database 105 configured to be used for determining an optimized value based on statistical information of mouse-over time during which a mouse cursor or pointer performs a mouse-over on an advertisement object, and statistical information of a duration time during which the mouse cursor positioned in a location of mouse-over on advertisement moves to a location outside the advertisement, and then record the determined optimized value in the user type database. The system 100 for displaying an expanded advertisement may set a different optimized value for each service page, and also set a different optimized value for each service page in consideration of user's attributes.

Further, the system 100 for displaying an expanded advertisement according to an embodiment of the invention further includes an advertisement data controlling unit 104 configured to identify an optimized value associated with the advertisement from the user type database 105 and permit the identified optimized value to be included in the advertisement data. In this instance, the advertisement data displaying unit 101 displays an advertisement including the optimized value, and the advertisement basis verifying unit 103 verifies whether the user's interaction satisfies the optimized value included in the advertisement data.

In this manner, according to an embodiment, when advertisement data including an optimized value is displayed on a service page and the user's interaction exists with respect to the displayed advertisement, the expanded advertisement is displayed by determining whether the user's interaction satisfies the optimized value, thereby increasing advertising effect.

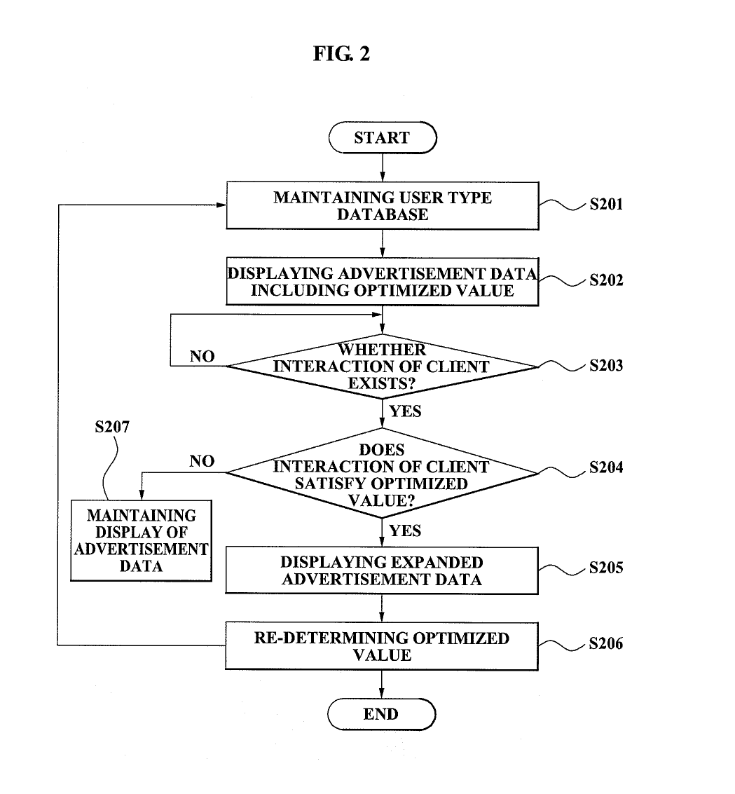

FIG. 2 is a flowchart illustrating a method for displaying expanded advertisement according to an embodiment of the present invention. In operation S201, the user type database 105 of the system 100 for displaying expanded advertisement determines an optimized value based on statistical information of mouse-over time during which a mouse cursor performs a mouse-over on advertisement, and statistical information of a duration time during which the mouse cursor positioned in a location of mouse-over on advertisement moves to a location outside of the advertisement, and then records the determined optimized value in the user type database.

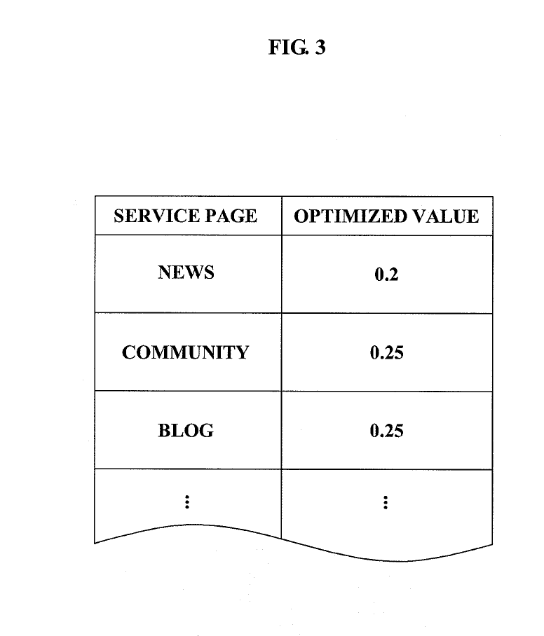

FIG. 3 is a diagram illustrating an example of a user type database according to an exemplary embodiment of the present invention. According to an embodiment of the invention, the user type database 105 sets a different optimized value for each service page, and records the set optimized value. The service page is provided for categories such as news, community, a blog, a dictionary, and the like, and the optimized value denotes a point in time when expanded advertisement depending on user's interaction or input is displayed.

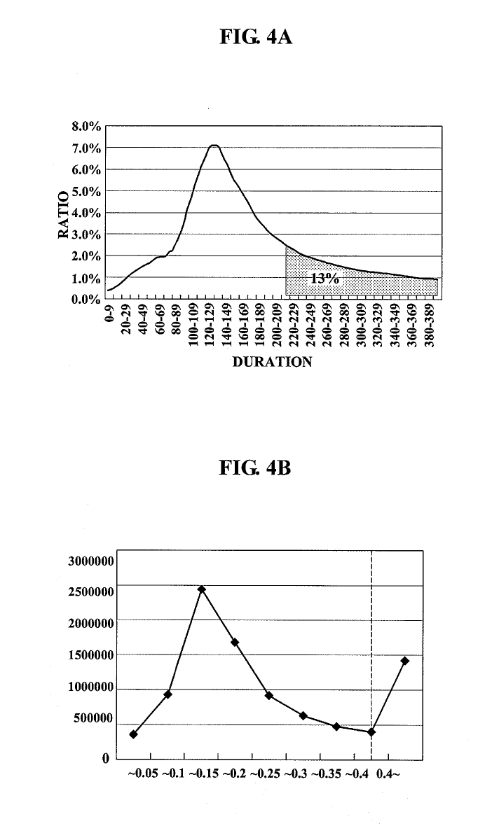

FIGS. 4A and 4B are graphs illustrating distribution of time statistics based on user's interactions according to an embodiment of the present invention. As illustrated in FIG. 4A, a vertical scale of the graph denotes the number of users and a horizontal scale thereof denotes a time period in 1/1000 seconds. That is, FIG. 4A is a graph illustrating distribution of a mouse drop time in which a mouse drop is performed such that a physical location of a mouse cursor is positioned on advertisement (mouse-over), and moved to a physical location outside the advertisement. In this instance, as can be seen from FIG. 4A, since a mouse cursor is positioned on the advertisement and moved a location outside the advertisement, the mouse drop time denotes a duration time. Specifically, the number of users who perform the mouse drop is increased until about 0.15 seconds, is greatest at about 0.15 seconds, and then continuously reduced. From this, it can be ascertained that users performing a mouse drop within about 0.15 seconds unintentionally position their mouse cursors on the advertisement.

Further, FIG. 4B is a graph illustrating distribution of a mouse-over time in which a mouse cursor is positioned on advertisement (mouse-over). In this regard, it is ascertained that, as can be seen from FIG. 4A, the number of users performing a mouse-over is increased until about 0.15 seconds and reduced after the max peak at about 0.15 seconds, however, again increased from about 0.4 seconds. From this, in the system 100 for displaying expanded advertisement, when a mouse cursor lingers over advertisement for about 0.4 seconds or more, it may be ascertained that the mouse cursor is not unintentionally positioned on the advertisement but intentionally positioned on the advertisement to see the advertisement, and thus, an optimized value may be determined as about 0.4 seconds.

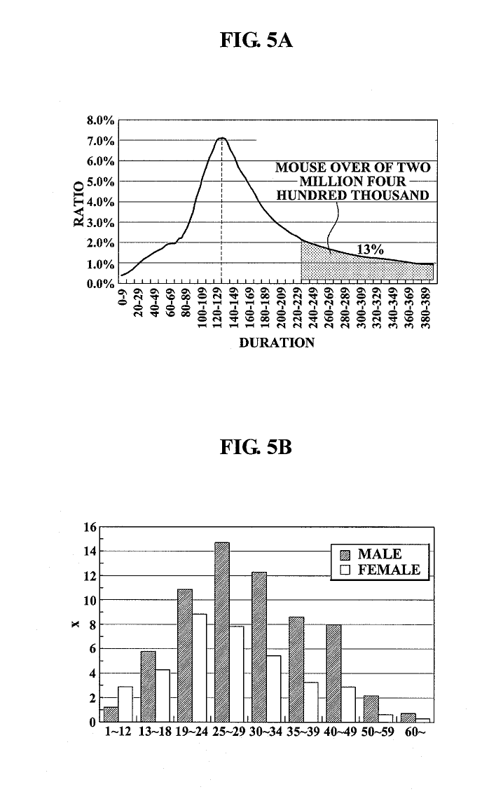

FIGS. 5A and 5B are graphs illustrating an example of distribution of user's interactions in a service page having a read property according to an exemplary embodiment of the present invention. Since, in a service page providing news, the number of users performing a mouser over is relatively small due to a tendency that users tend to verify contents of news, there occurs a need for securing a few more users.

As illustrated in FIG. 5A, since the number of users performing a mouse drop is the greatest at 0.13 seconds and then shows a steeper decline, the about 0.13 seconds is deemed as a point of time when advertisement is unintentionally displayed. Further, as illustrated in FIG. 5B, a male and female ratio of users performing a mouse-over is relatively greater in males (shown as oblique lines), and accordingly, it can be seen that movement of a mouse cursor of males is relatively fast and a speed of verifying contents is faster than average.

Thus, in the system 100 for displaying expanded advertisement, in a service page having a reading property such as news, about 0.2 seconds which is less than about 0.4 seconds of an average of an optimized value is set as an optimized value. As a result, the system 100 for displaying expanded advertisement may obtain greater advertising effect because of securing about 2.4 million more users than when the optimized value is set as about 0.4 seconds.

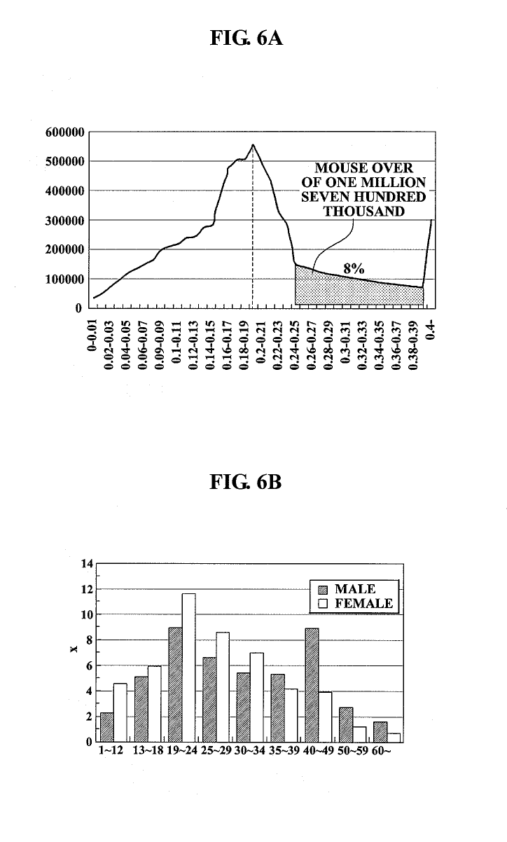

FIGS. 6A and 6B are graphs illustrating an example of distribution of user's interactions in a service page having a write property according to an exemplary embodiment of the present invention. As to a service page of a community, since the use purpose and use range of a mouse cursor is not constant due to a allowance of writing provided in the service page, the number of users performing a mouse-over is relatively great, and thus, it is sufficient merely to ensure that an adequate number of users is secured. As illustrated in FIG. 6A, since the number of users performing a mouse drop is greatest at about 0.2 seconds, and then shows a steeper decline, about 0.2 seconds is deemed as a point of time when an advertisement is unintentionally displayed. Also, as illustrated in FIG. 6B, a male and female component ratio of viewers performing a mouse-over is relatively greater in female, and accordingly, it can be seen that movement of a mouse cursor of female is relatively slow.

Thus, in the system 100 for displaying expanded advertisement, in a service page having a writing property such as a community, about 0.25 seconds which is less than about 0.4 seconds of an average of an optimized value is set as an optimized value. As a result, the system 100 for displaying expanded advertisement may obtain relatively greater advertising effect because of securing about 1.7 million more users than when the optimized value is set as about 0.4 seconds.

According to an embodiment of the invention, the system 100 for displaying expanded advertisement may set a different optimized value for each service page in consideration of users' attributes. Referring to FIGS. 5A, 5B, 6A, and 6B, in the system 100 for displaying expanded advertisement, a male ratio of users is relatively greater in the service page of news, thereby being fast in terms of the movement of a mouse cursor, and conversely, a female ratio of users is relatively greater in the service page of community, thereby being slow in terms of the movement of the mouse cursor, and hence, a different optimized value is set for each service page in consideration of users' attributes.

In operation S202, in the system 100 for displaying expanded advertisement, the advertisement data displaying unit 101 detects that a user accesses a service page and displays advertisement data including an optimized value on the service page. The advertisement data controlling unit 104 may permit optimized values, which are set to be different for each service page, to be included in advertisement data to be displayed on each service page, and the advertisement data displaying unit 101 may display the advertisement data including the optimized values on service pages.

In operation S203, in the system 100 for displaying expanded advertisement, the interaction determining unit 102 determines existence of user's interaction with respect to the displayed advertisement on the service page. The user's interaction denotes a user's reaction such as a mouse-over positioned on the advertisement. According to the present exemplary embodiment of the invention, the user's interaction may include the case where the user clicks the advertisement, or a mouse drop where the mouse cursor is moved to a physical location outside the advertisement data in a state where the mouse-over is performed.

The interaction determining unit 102 transmits user's interaction to the advertisement basis verifying unit 103 when the user's interaction, thereby performing operation S204, and repeatedly performs operation S203 when the user's interaction does not exist, and thus determining existence of user's interaction.

In operation S204, in the system 100 for displaying expanded advertisement, the advertisement basis verifying unit 103 verifies whether user's interaction satisfies a predetermined advertisement displaying basis. The advertisement displaying basis is to set points of time of displaying expanded advertisement depending on user's interactions, that is, the optimized value as described in the user type database 105 may be the advertisement displaying basis. The advertisement basis verifying unit 103 verifies whether a time period during which a mouse-over is performed on the displayed advertisement satisfies an optimized value included in the displayed advertisement.

When the time period during which the mouse-over is performed satisfies the optimized value, operation S205 is performed, thereby displaying expanded advertisement, and conversely, when the time period during which the mouse-over is performed does not satisfy the optimized value, the displayed advertisement is maintained in operation S207. In operation S205, in the system 100 for displaying expanded advertisement, the advertisement data displaying unit 101 displays expanded advertisement on the service page.

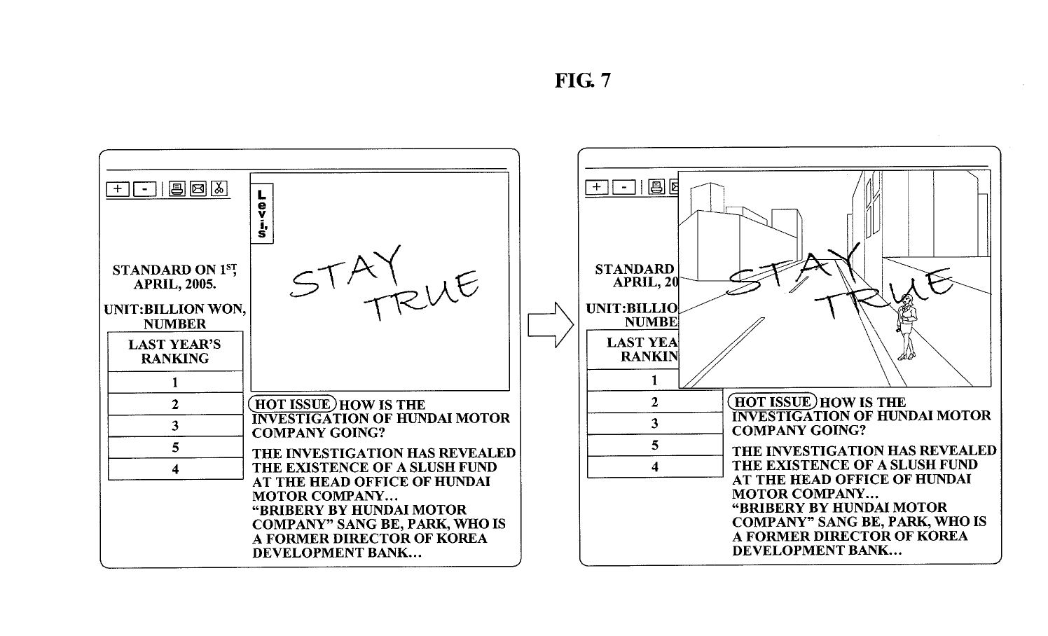

FIG. 7 is a view illustrating an example in which expanded advertisement is displayed according to an exemplary embodiment of the present invention. As shown in FIG. 7, advertisement shown in the left hand side of FIG. 7 denotes displayed advertisement on the service page, and advertisement data shown in the right hand side thereof denotes expanded advertisement in which advertisement is shown on a greater advertisement region than an original advertisement region. In this manner, the system 100 for displaying expanded advertisement displays expanded advertisement on a greater advertisement region than an original advertisement region on a service page, thereby increasing advertising effect.

In operation S206, the system 100 for displaying expanded advertisement obtains interactions of each user for a predetermined period of time and re-determines the optimized value. The optimized value as described above is determined based on interactions of each user. Therefore, interactions of each user are observed for each service page for a predetermined period of time, and then the optimized value may be changed, thereby increasing advertising effect.

The method for displaying expanded advertisement according to embodiments of the invention may be recorded in a computer-readable recording media including program instructions to implement various operations embodied by a computer. The computer-readable medium may include program instructions, data files, a data structure or a combination thereof. The program instructions recorded in the computer-readable medium may be specially designed and constructed for embodiments of the present invention, or be well known to those skilled in the field of computer software. Examples of computer-readable medium include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The hardware devices may be constructed to act as one or more software modules for performing the operation of embodiments of the present invention, and vice versa.

As described above, according to the method and the system for displaying an expanded advertisement of embodiments of the present invention, advertisement data including an optimized value is displayed on a service page, and whether user's interaction satisfies the optimized value is determined when the user's interaction exists with respect to the displayed advertisement, thereby displaying expanded advertisement, and accordingly, maximizing advertising effect.

Further, according to the method and the system for displaying an expanded advertisement of embodiments of the present invention, since user's interactions are varied according to characteristics of each service page such as news, e-mail, a blog, a dictionary, and the like, based on statistical information of mouse-over time and duration time of each user, a different optimized value may be set for each service page.

Also, according to the method and the system for displaying an expanded advertisement of embodiments of the present invention, an optimized value is re-determined by obtaining interactions of each user when expanded advertisement is displayed, so that a displayed timing of the expanded advertisement depending on user's reactions is effectively determined.

Although embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for displaying an advertisement, the method comprising:
receiving, by a computing device, advertisement data from a remote source, wherein the advertisement data is configured to display an advertisement on a display screen associated with the computing device, wherein the advertisement data comprises an optimized condition for expanding the advertisement such that further information relating to the advertisement is to be displayed on the display screen;
monitoring, by the computing device, a user input to the computing device;
determining, by the computing device, whether the user input satisfies the optimized condition; and
expanding the advertisement so as to display the further information on the display screen when the user input satisfies the optimized condition.

2. The method of claim 1, wherein the user input comprises at least one of a stay of a pointer over the advertisement on the display screen and a keyboard input to the computing device.

3. The method of claim 1, wherein the optimized condition is produced by a method which comprises:
providing statistical data of a period during which Internet users stay their pointers over an Internet advertisement that is configured to expand the Internet advertisement to display additional information when a pointer is placed over the Internet advertisement; and
determining the optimized condition based on the statistical data.

4. The method of claim 3, wherein the optimized condition comprises a threshold, which is a minimum period required for a pointer to stay over the advertisement for displaying the further information.

5. The method of claim 1, wherein the optimized condition is produced by a method which comprises:
providing first statistical data of a period during which Internet users stay their pointers over Internet advertisements, wherein the first statistical data is obtained in a context where the Internet advertisement that is displayed on a first type of webpages;
providing second statistical data of a period during which Internet users stay their pointers over Internet advertisements, wherein the second statistical data is obtained in a context where the Internet advertisement that is displayed on a second type of webpages, which is different from the first type; and
determining the optimized condition comprising a first optimized value based on the first statistical data and a second optimized value based on the second statistical data, wherein the first value is a minimum period required for a pointer to stay over the advertisement for displaying the further information when the advertisement is displayed in a webpage of the first type, wherein the second value is a minimum time required for a pointer to stay over the advertisement displaying the further information when the advertisement is displayed in a webpage of the second type.

6. The method of claim 5, wherein the first type of webpages comprises news media webpages, and the second type of webpages comprise individuals' blog webpages.

7. The method of claim 6, wherein the first value is smaller than the second value.

8. The method of claim 6, wherein the first value is smaller than the second value by a range from about 0.03 seconds to about 0.07 seconds.

9. The method of claim 6, wherein the first value is from about 0.18 seconds to about 0.22 seconds.

10. A computer executable command for use in connection with a webpage, wherein the command is to initiate the method of claim 1.

11. A method for displaying an advertisement, the method comprising:
receiving, by a computing device, advertisement data configured to display an advertisement on a display screen associated with the computing device, wherein the advertisement data comprises a predetermined condition for expanding the advertisement such that further information relating to the advertisement is to be displayed on the display screen, wherein the predetermined condition comprises a minimum period that is required for a pointer to stay over the advertisement for displaying the further information; and
expanding the advertisement so as to display the further information on the display screen when the pointer stays over the advertisement for the minimum period or longer.

12. The method of claim 11, wherein the computing device monitors motions of the pointer so as to determine whether the pointer stays over the advertisement for the minimum period or longer.

13. The method of claim 11, wherein the minimum period is longer than about 0.18 seconds.

14. The method of claim 11, wherein the minimum period is longer than about 0.25 seconds.

15. The method of claim 11, wherein the minimum period is longer than about 0.4 seconds.

16. A method for displaying advertisements, the method comprising:
receiving, by a computing device, first advertisement data configured to display a first advertisement along with a first webpage on a display screen associated with the computing device, wherein the first advertisement data further comprises a first predetermined condition for expanding the first advertisement such that first additional information relating to the first advertisement is to be displayed on the display screen, wherein the first predetermined condition comprises a first minimum period that is required for a pointer to stay over the first advertisement for displaying the first additional information;
expanding the first advertisement so as to display the first additional information on the display screen when a pointer on the display screen stays over the first advertisement for a period that is identical to or longer than the first minimum period;
receiving, by the computing device, second advertisement data configured to display a second advertisement along with a second webpage on the display screen, wherein the second advertisement data further comprises a second predetermined condition for expanding the second advertisement such that second additional information relating to the second advertisement is to be displayed on the display screen, wherein the second predetermined condition comprises a second minimum period that is required for a pointer to stay over the second advertisement for displaying the second additional information;
expanding the second advertisement so as to display the second additional information on the display screen when a pointer on the display screen stays over the second advertisement for a period that is identical to or longer than the second minimum period; and
wherein the first minimum period differs from the second minimum period.

17. The method of claim 17, wherein the first webpage is a news media webpage, and the second webpage is an individual's blog.

18. The method of claim 17, wherein the first minimum period is shorter than the second minimum period.

19. The method of claim 17, wherein the first minimum period is shorter than the second minimum period by a range from about 0.03 seconds to about 0.07 seconds.

20. The method of claim 17, wherein the first minimum period is from about 0.18 seconds to about 0.22 seconds.
